(19) United States
(12) Patent Application Publication
(10) Pub. No.: US 2025/0077725 A1
(43) Pub. Date: Mar. 6, 2025

(54) INERTER FINITE ELEMENT SIMULATION METHOD, SOFTWARE APPARATUS, ELECTRONIC DEVICE, AND STORAGE MEDIUM

(71) Applicants: Shenzhen University, Shenzhen (CN); Central South University, Changsha (CN)

(72) Inventors: Can Shi, Shenzhen (CN); Yu Zhou, Shenzhen (CN); Yanliang Du, Shenzhen (CN); Lei Xu, Shenzhen (CN); Yun Li, Shenzhen (CN)

(21) Appl. No.: 18/797,972

(22) Filed: Aug. 8, 2024

(30) Foreign Application Priority Data
Sep. 5, 2023 (CN) 2023111403895

(51) Int. Cl. G06F 30/17

(52) U.S. Cl. CPC G06F 30/17

(57) ABSTRACT

Introduced are a method, a software apparatus, an electronic device, and a storage medium for simulating inerter using finite element analysis. The method involves: acquiring structural parameters of an inerter; simulating the mechanical properties of racks on rigid rods and flywheels within the inerter using the structural parameters and a finite element platform; formulating constraint equations and transformation formula to simulate translational-rotational conversion and inertia amplification mechanism of the inerter; integrating the force and constraint information to achieve the finite element simulation of the inerter. The finite element simulation method for the inerter addresses the challenge of lacking “inerter units” and the inability to simulate inertia components in general finite element software platforms. It also overcomes the technical bottleneck of real-time dynamic coupling simulation between inerter and complex engineering structures. This may effectively promote the design, optimization, and application of inerter in the vibration control of large-scale engineering structures.

### TECHNICAL FIELD

This invention relates to the field of computer simulation for engineering structural vibration reduction, particularly involving an finite element simulation method of inerter, software device, electronic device, and storage medium.

### BACKGROUND

In 2002, British researcher Smith first proposed the concept of “inerter” during the study of the force-electricity analogy between mechanics and electronics. Inerter is characterized by the magnitude of the force is proportional to the relative acceleration of the two end points, and the ratio is called the “inerter coefficient”. The general expression of inerter is F=b(\ddot{x}₂−\ddot{x}₁), where, \ddot{x}₁, \ddot{x}₂ are the accelerations of the two endpoints, respectively; b is the inerter coefficient with units in kilograms (kg).

Since of the concept of inerter was introduced, various mechanical structures of inerter have been developed. These mechanisms invariably incorporate three essential elements: a transmission mechanism, an inertia mechanism, and two endpoints capable of relative motion. An inertia mechanism refers to a mechanical structure that amplifies the inertia of a device through some form of inertia amplification mechanism, typically driven by a transmission mechanism.

Research on theory and experimental testing of inerter indicates that the inerter coefficient can be much greater than the physical mass of the object itself. This feature offers several advantages, including inertia amplification, damping enhancement, attenuation of high-frequency vibrations while permitting low-frequency vibration, negative stiffness, broadening of vibration reduction bandwidth, and anti-resonance, among others. Currently, scholars have successfully applied the inerter to practical engineering projects such as Formula 1 racing cars, motorcycles, seismic resistance of NTT buildings, and vibration reduction for the Zhangjiajie Grand Canyon glass bridge, achieving favorable results. This also highlights the broad prospects of inerter for vibration control in various engineering fields, including automobiles, trains, aviation, bridges, and marine engineering.

In present-day theoretical research on structural vibration control using inerter, the typical approach involves simplifying the vibration reduction object and employing self-programmed methods to solve control equations. This approach encounters challenges when addressing the dynamic interaction between inerters and complex engineering structures, as formulating control equations and developing numerical solution programs proves difficult for the complex structure. As a result, this limitation impedes research on vibration reduction design and optimization of large-scale engineering structures incorporating inerter and further hinders the practical application of inerter in complex engineering structures.

The finite element method and general finite element software platforms are capable of handling specific geometric and material properties, various complex loads, and boundary conditions. They allow for flexible modeling, accurate solving, and convenient analysis of structures, thus serving the optimization of complex and large-scale engineering structural design over the long term. However, due to the novelty of inerter as a mechanical concept, general finite element software platforms (such as ANSYS, ABAQUS, etc.) still lack corresponding “inerter unit” and the finite element simulation methods for inerter has also not been developed yet.

Considering this situation, the invention discloses a finite element simulation method for inerter, with the aim of promoting research on inerter systems based on the finite element method and facilitating the design optimization and application of inerter in vibration control for complex engineering structures.

### SUMMARY

Based on the discussion above, it is necessary to provide an inerter finite element simulation method, software device, electronic equipment, and storage medium for at least one of the mentioned issues.

The first aspect of the invention provides a finite element simulation method of the inerter, including the following steps:
obtaining the structural parameters include dimensional and positional information of the inerter;
simulating the physical and mechanical properties of the rigid rod and the flywheel in the inerter based on the structural parameters and the finite element platform, within the local coordinate system of the finite element platform;
simulating the translational-rotational conversion and inertia amplification mechanisms of the inerter based on the conversion functions, which are determined by the rack on the rigid rod and the flywheel, as well as their physical and mechanical properties; and
obtaining force and constraint information of the inerter, and integrating the translational-rotational conversion and inertia amplification mechanisms to achieve simulation of the inerter in the finite element platform.

In certain implementations of the first aspect, the steps in the local coordinate system of the finite element platform include:
constructing a spatial local coordinate system within the spatial global coordinate system of the finite element platform, where the local coordinate system is a cartesian coordinate system; and
aligning the principal axis of inerter along the Y-axis direction of the local coordinate system.

Combining the first aspect and the above implementation, in certain implementations of the first aspect, the steps for simulating the translational-rotational conversion and inertia amplification mechanism of the inerter include:
constructing constraint equation for the axial translational displacement at both ends of the inertia and the angular displacement of the flywheel, to simulate the translational or rotational displacement conversion relationship between the rigid rod and the flywheel; and
constructing the transformation formula between the axial forces at both ends of the inerter and the torque on the flywheel in the finite element platform to simulate the inertia amplification mechanism, and combining the constraint equation to simulate the translational-rotational conversion and inertia amplification mechanism of the inerter.

Combining the first aspect and the above implementation, in certain implementations of the first aspect, the steps for implementing simulation of the inerter in the finite element platform specifically include:
based on the force and constraint information, establishing the connection relationship information between the inerter and the attached structures; and
integrating the constraint equation and transformation formula simulated in the finite element platform to complete the finite element simulation of the inerter.

Combining the first aspect with the above implementation, in certain implementations of the first aspect, after implementing the simulation of the inerter in the finite element platform, the method further includes:
constructing additional attached structures apart from the inerter in the global coordinate system of the finite element platform;
based on the actual connection relationship between the attached structures and the inerters, receiving external load information applied on both the attached structures and the inerters; and
utilizing the computational process of the finite element platform to solve and obtain the dynamic response data of the inerters and the attached structures.

Combining the first aspect with the above implementation, in certain implementations of the first aspect, the inerter, such as, a gear rack mechanism or a ball screw mechanism can be simulated in general finite element software platforms.

The second aspect provides a software apparatus for the finite element simulation of inerter, including: a first module, a second module, a third module, and a fourth module.

The first module is used to obtain the structural parameters include dimensional information and positional information of the inerter.

The second module is used to simulate the physical and mechanical properties of the rigid rods and flywheels in the inerter based on the structural parameters and the finite element platform, within the local coordinate system of the finite element platform.

The third module is used to simulate the translational-rotational conversion and inertia amplification mechanism of the inerter based on the conversion functions of racks on rigid rods and flywheels, as well as their physical and mechanical properties.

The fourth module is used to obtain force and constraint information of the inerter, and to integrate the translational-rotational conversion and inertia amplification mechanism to achieve simulation of the inerter in the finite element platform.

The first module is embodied by software stored in at least one memory and executable by at least one processor; likewise, the second module is embodied by software stored in at least one memory and executable by at least one processor; likewise, the third module is embodied by software stored in at least one memory and executable by at least one processor; likewise, the fourth module is embodied by software stored in at least one memory and executable by at least one processor.

In certain implementations of the second aspect, the fourth module is further used to construct additional attached structures apart from the inerter in the global coordinate system of the finite element platform. It receives external load information applied on both the attached structures and the inerter based on the actual connection relationship between the attached structures and the inerters. It then utilizes the computational process of the finite element platform to solve and obtain the dynamic response data of the inerters and the attached structures.

The third aspect provides an electronic device, including: one or more processors, a storage memory, and one or more programs; the one or more programs are stored in the storage memory and configured to be executed by the one or more processors. The one or more programs are configured to implement any one of the inerter finite element simulation methods described in the first aspect of the invention.

The fourth aspect provides a computer-readable storage medium, the computer-readable storage medium stores at least one instruction, at least one program, code set, or instruction set. The at least one instruction, at least one program, code set, or instruction set is loaded and executed by the processor to implement any one of the inerter finite element simulation methods described in the first aspect of the invention. The computer-readable storage medium is a non-transitory computer-readable storage medium.

The technical solutions provided in the implementations of the present invention bring the following beneficial technical effects:

A finite element simulation method for inerter is provided that accurately simulates the physical and mechanical properties and dynamic response of the inerter, facilitating understanding the working and vibration control principles of the inerter.

By simulating the inerter on a finite element platform, the technical bottleneck of real-time dynamic coupling simulation between inerter and large-scale engineering structures is overcome, enabling the design and optimization of inerter for structural vibration control.

A software apparatus for inerter finite element simulation is provided, allowing for more convenient simulation of inerter, thereby enhancing efficiency and accuracy in engineering application.

An electronic device and computer-readable storage medium are provided, facilitating the application of the inerter finite element simulation method, which can be widely used in engineering design and scientific research fields.

The additional aspects and advantages of the present invention will be provided in subsequent sections, and will be further understood from the detailed description in the following sections, or through implementation cases of the invention.

### BRIEF DESCRIPTION OF THE DRAWINGS

FIG. 1 is a schematic diagram of the process of the finite element simulation method for inerter in one implementation of the present invention.

FIG. 2 is a schematic diagram of the structure of a gear-rack-type inertia with a single gear and a single flywheel in one implementation of the present invention.

FIG. 3 is a schematic diagram of the structure of a ball screw-type inertia in one implementation of the present invention.

FIG. 4 is a schematic diagram of the finite element simulation for inerter in one implementation of the present invention.

FIG. 5 is a schematic diagram of the mechanical model of a single-degree-of-freedom system containing TVMD in one implementation of the present invention.

FIG. 6 is a schematic diagram illustrating the conceptual approach to simulation of a single-degree-of-freedom system with TVMD inerter subjected to harmonic loading in one implementation of the present invention.

FIG. 7 is a schematic diagram illustrating the finite element simulation for inerter of a single-degree-of-freedom system with TVMD subjected to harmonic loading in one implementation of the present invention.

FIG. 8 is a schematic diagram of the first comparative results of simulations using finite element platforms in an implementation of the present invention.

FIG. 9 depicts the second set of comparative results of simulations using finite element platforms in an implementation of the present invention.

FIG. 10 illustrates the third set of comparative results of simulations using finite element platforms in an implementation of the present invention.

FIG. 11 presents a schematic diagram of the structural framework of the finite element simulation for inerter in an implementation of the present invention.

FIG. 12 illustrates the schematic diagram of the structural framework of the electronic device in an implementation of the present invention.

### DETAILED DESCRIPTION OF EMBODIMENTS

To facilitate understanding of the present invention, a more comprehensive description of the invention will now be provided with reference to the accompanying drawings. The drawings also illustrate possible implementations of the present invention. However, the present invention can be implemented in many different forms and is not limited to the implementations described herein with reference to the drawings. The implementations described with reference to the drawings are exemplary and are intended to provide a thorough and comprehensive understanding of the disclosed content of the present invention, and should not be construed as limiting the invention. Additionally, if detailed descriptions are unnecessary for illustrating the features of the present invention, such technical details may be omitted.

Professionals in the relevant field will recognize that, unless otherwise specified, all terms used herein (including technical and scientific terminology) carry the same meanings as commonly understood by those skilled in the particular field of the present invention. It should also be noted that terms found in general dictionaries should be interpreted in a manner consistent with their meanings in the context of the relevant invention, and should not be given an overly formal or idealized interpretation unless explicitly defined as such in this document.

Professionals in this technical field will understand that, unless explicitly stated, the singular forms “a,” “an,” “the,” and “should” may also include plural forms. It should be further understood that the term “comprising” used in the specification of the invention indicates the presence of the stated features, integers, steps, operations, components, and/or elements, but does not preclude the presence or addition of one or more other features, integers, steps, operations, components, elements, and/or groups thereof. Besides, the term “and/or” used here encompasses all or any one of the units of the listed items and all combinations thereof.

The finite element method and general finite element software platforms can handle special geometric and material properties, various complex loads, and boundary conditions. They allow for flexible modeling of structures, accurate solutions, and convenient analysis, serving long-term in the design and optimization of large-scale engineering structures. However, due to the inerter being a newly proposed mechanical concept and its finite element simulation method being less mature, current major general finite element software platforms (such as ANSYS, ABAQUS, etc.) lack corresponding “inerter units” for inertia mechanics components, restricting the development of complex engineering structure vibration control design based on finite element methods and general finite element software platforms, thus impeding the practical application of inertia in large-scale engineering structures.

The inerter finite element simulation method, software device, electronic equipment, and storage medium provided by the present invention aim to address the aforementioned technical issues.

The following is a detailed explanation of the technical solution provided by the present invention and how it addresses the technical issues mentioned above, using specific implementation cases.

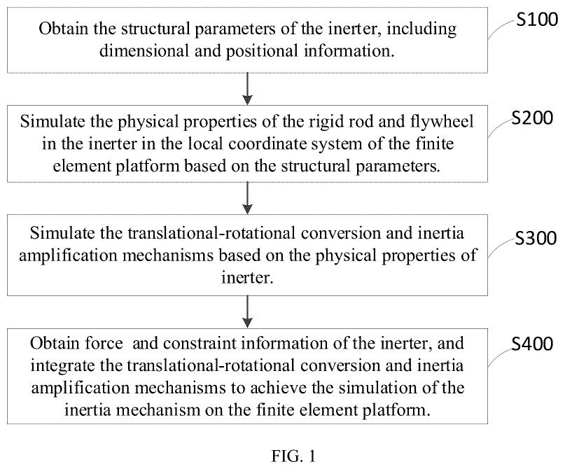

The implementation of the first aspect of the present invention provides an inerter finite element simulation method, as shown in FIG. 1, including the following steps: S100 to S400.

S100: Obtain the structural parameters of the inerter, including dimensional and positional information. The structural parameters of the inerter can be obtained in advance through measurement tools or sensors. These dimensional and positional information, enable to locate the inerter on the finite element platform. For example, dimensional information such as the radius of the flywheel and the overall mechanical gear ratio, mechanical information such as the physical mass of the flywheel, and positional information such as the spatial position of the inerter relative to the attached structure (large-scale engineering structure) or the spatial position of the two endpoints of the inerter relative to the flywheel and the attached structure.

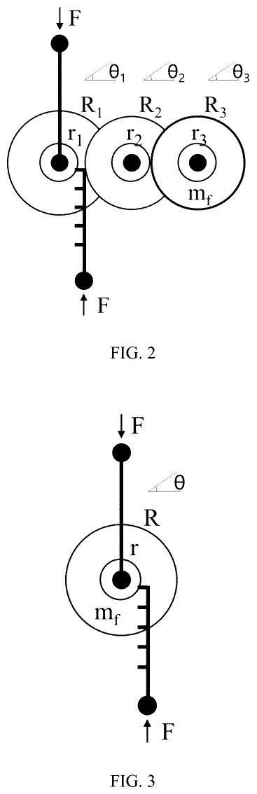

The inertia mechanism, abbreviated as the inerter, refers to a class of devices or mechanical structure with inertial mechanical properties and physical forms, such as gear-rack-type inerters and ball screw-type inerters, as shown in FIGS. 2 and 3. Both gear-rack-type and ball screw-type inerters utilize translational-to-rotational conversion mechanisms to achieve inertia amplification, with only slight differences in the transmission mechanism. These two mechanical inerters exhibit high similarity and uniformity, thereby enabling the establishment of a generalized mathematical expression for inertia based on translational-to-rotational conversion mechanisms. The two endpoints of the inerter are respectively connected to a attached structure and the ground or between two attached structures.

The inerter includes 2 endpoints and 1 flywheel, with 1 rigid link that is non-expandable and axially loaded, and 1 expandable rack (or screw) under axial load. Corresponding to the finite element platform, the number of nodes in the inerter unit is 3, representing two endpoints and one flywheel. The two endpoints of the inerter, or at least one endpoint, have axial translational degrees of freedom, ensuring relative linear motion between the two endpoints. The flywheel of the inerter has rotational degrees of freedom, assigning axial translational degrees of freedom to the two end nodes and rotational degrees of freedom to the middle node. Regarding the rigid link as a “rigid arm” and employing rigid spring elements in the finite element platform simulation method, this approach not only reflects the small axial deformation and deformation characteristics of the rigid link under axial tension and compression but also reduces the degrees of freedom compared to use rigid beam elements.

S200: Based on the structural parameters of inerter and the finite element platform, simulate the physical mechanical properties of the rigid link and flywheel in the inerter in the local coordinate system of the finite element platform. Combining the structural parameters obtained in S100 with the existing elements and parameters in the finite element platform, simulate the physical mechanical properties of the rigid link and flywheel in the inerter. Specifically, set the density (corresponding to weight), rotational inertia, and stiffness of the inerter in the finite element platform, making the inerter tangible in the finite element platform, resembling an actual physical structure rather than just a geometric concept.

S300: Simulate the translational-to-rotational conversion and inertial amplification mechanism of the inerter based on the conversion functions of the rack on the rigid link and flywheel, as well as their physical mechanical properties.

S400: Obtain the force and constraint information of the inerter, and combine them with the translational-to-rotational conversion and inertial amplification mechanism to simulate the inerter on the finite element platform.

The finite element simulation method of inerter provided by the present invention analyzes the characteristics of the inerter, selects the basic nodes related to inerter, incorporates the parameters of these basic nodes into the finite element platform, and utilizes the inherent functionality of the finite element platform to achieve simulation of the interaction between the inerter and attached structures. This method expands the research approaches for inerter, improves the theoretical simulation and analysis level of inerter, breaks through the technical bottlenecks of coupled numerical simulation and simulation analysis of inertia with complex engineering structures, and further provides effective theoretical guidance for practical engineering applications of inerter.

Specifically, in the first aspect implementation example, step S200 in the local coordinate system of the finite element platform includes: 1) constructing a spatial local coordinate system within the spatial global coordinate system of the finite element platform, where the local coordinate system is a cartesian coordinate system; 2) orienting the inertia main axis (i.e., principal axis of the inerter) is along the Y-axis direction of the local coordinate system.

The finite element platform typically utilizes a global coordinate system, which is commonly a cartesian coordinate system. Establishing a local coordinate system within the global coordinate system facilitates the adjustment of the orientation and position of inerter. This adjustment can be made without affecting the data simulation of other structures in the global coordinate system.

Based on the structural parameters obtained in S100, the node coordinates of the rigid rod and the flywheel are set in the local coordinate system. The direction of the flywheel's rotational inertia is determined, with the rotational inertia direction of the gear-rack inertia perpendicular to the main axis, and the rotational inertia direction of the ball screw inerter parallel to the main axis. In fact, according to the differences between gear-rack and ball screw inerters, the direction of the flywheel's rotational degree of freedom can either be perpendicular or parallel to the inertial axis. Therefore, when selecting the rotational inertia property, any of IXX, IYY, or IZZ can be chosen, with the same effect. When setting up the local coordinate system, the inertial axis can be aligned along the Y-axis.

Specifically, in conjunction with the first aspect and the aforementioned implementation, the steps of simulating the translational-rotational conversion and inertial amplification mechanism of the inerter mechanism in S300 include the following: 1) formulate constraint equation for the axial translational displacement of the inerter's two endpoints and the angular displacement of the flywheel, to determine the translational or rotational displacement conversion relationship between the rigid link and the flywheel; 2) construct the conversion formula based on the relationship between the axial forces at the two endpoints of the inerter and the torque on the flywheel within the finite element platform. Combine this with the constraint equations to simulate the translational-rotational conversion and inertial amplification mechanism of the inerter.

The translational-rotational conversion mechanism refers to the process where the axial forces acting on the two endpoints of the inerter are transmitted through a transmission mechanism to generate torque on the flywheel. This torque then drives the rotational motion of the flywheel, converting the translational motion (i.e., linear motion) of the two endpoints driven by the axial forces into rotational motion driven by the torque on the flywheel. As a results, this process achieves the inertial amplification characteristic of the inerter.

Considering the conversion direction of the rack or screw on the rigid link and flywheel, establish constraint equation for the axial translational displacement of the two endpoints of the inerter and the angular displacement of the flywheel. This facilitates the mutual conversion between translational and rotational displacements of the rigid link and flywheel. Subsequently, establish conversion formula for the axial forces on the two endpoints of the rigid link and the torque on the flywheel base on the physical and mechanical properties of inerter. This enables the simulation of the inertial amplification mechanism of the inerter on the finite element platform.

Taking rack-and-pinion type inerter and ball screw type inerter as the research objects, analyze the working mechanism of translational-rotational conversion inerter and derive the general mechanical expression for translational-rotational conversion inerter. The specific process of translational-rotational conversion mechanism analysis is as follows:
1) The ratio of the inerter flywheel angular displacement θ to the relative translational displacement of the two endpoints Δx is directly proportional to the reciprocal of the flywheel gear radius r, denoted as Γ. The conversion formula between the flywheel angular displacement and the translational displacement of the two endpoints satisfies:

$$\frac{θ}{Δ x} {=}^{def} Γ$$

2) The ratio of the axial force F acting on the endpoints of the two types of inerter mechanisms (gear-rack type and ball screw type) to the torque T on the flywheel is also proportional to the reciprocal of the flywheel gear radius r, and this ratio is also equal to Γ. The relationship between the axial force on the endpoints and the torque on the flywheel satisfies:

$$\frac{F}{T} {=}^{def} Γ$$

3) The effect of the torque on the flywheel of the two types of inerter mechanisms is to rotate the flywheel with an angular acceleration of \ddot{θ}, where, I=m_{f}R², m is the physical mass of the flywheel, r is the radius of flywheel. The torque conforms to:

$$T = I \cdot \ddot{θ}$$

4) Establish the expression of the inerter:

$$F = {Γ}^{2} \cdot I \cdot Δ \ddot{x} = {m}_{b} \cdot Δ \ddot{x}$$

5) The inertial amplification feature manifests as the physical mass m_{f} of the inerter mechanism's flywheel being amplified to an inertia coefficient (also called inertia mass) m_{b}.

$${m}_{b} = {Γ}^{2} \cdot I = {Γ}^{2} \cdot {R}^{2} \cdot {m}_{f}$$

6) Determine the direction of the rotational inertia. Based on the differences and connections in the directions of rotational inertia in gear-rack and ball screw inerter, it is found that the direction of rotational inertia of the inerter's flywheel, based on the translational-to-rotational conversion mechanism, can be either perpendicular to or parallel with the main axis of the inerter.
7) The inerter expressions not only comply with the inertial mechanical characteristics of both types of inerter (gear-rack type and ball screw type) but also apply to all inerter based on the translational-to-rotational conversion mechanism.

Specifically, combine the aforementioned approach and the implementation case of the first aspect, the steps of simulating the inerter on the finite element platform in S400 include: setting up the connection relationship information between the inerter and the attached structure based on the force and constraint information; integrating the simulation of translational-to-rotational conversion and inertia amplification mechanism conducted on the finite element platform to complete the finite element simulation of the inerter.

Combining the implementation case of the first aspect with the above-mentioned methods, in implementation case of the first aspect, following the steps of simulating the inerter on the finite element platform in S400 should further including:

In the global coordinate system of the finite element platform, modelling attached structures apart from the inerter.

Based on the actual connection relationship between the attached structures and the inerter, external load information applied to the attached structures and the inerter is determined.

Using the computational algorithm in the finite element platform to solve and run simulations, dynamic response data of the inerter and attached structures are obtained.

The inerter finite element simulation method established based on the translational-to-rotational conversion mechanism condensed from the above process embodies the complete conceptual framework of inerter mechanics expressions. It possesses universal adaptability and can characterize inerter with arbitrary structure forms and inertia masses.

Combining the previous implementations, the simulation of the translational-to-rotational conversion and inertia amplification mechanism of the inerter in S300 to S400 now reflects the implementation of inerter finite element method based on the translational-to-rotational conversion mechanism.
1) Based on the refined translational-to-rotational conversion mechanism, inerter, referred to as “inerter units” in finite element software, are established using finite element software platforms.
2) Establishing coordinate systems. Establish a local coordinate system where the main axis of the “inerter units” aligns with the Y-axis. Adjustments to the orientation and position of the “inerter units” in the main coordinate system can be achieved by manipulating the local coordinate system.
3) Create nodes. Establish three nodes corresponding to the positions of the two endpoints (typically labeled as Node 1 and Node 3) and the flywheel (labeled as Node 2) in the inerter.
4) Simulation of the rigid link of the inerter. Utilize rigid spring elements to simulate the rigid link of the inerter.
5) Establish constraint equation to simulate the translational-to-rotational conversion relationship. These equations model the relationship between translational displacement and angular displacement, as well as the relationship between axial forces on the two endpoints and the torque on the flywheel.

Based on the translational-to-rotational conversion mechanism and the relationship between the relative translational motion of the two endpoints and the rotational motion of the flywheel, the following equations of degrees of freedom are derived:

$$ROTZ ( 2 ) = Γ \cdot ( UY ( 3 ) - UY ( 1 ) )$$

Where, ROTZ(2) represents the rotational degree of freedom of the flywheel about the Z-axis (or ROTX(2) about the X-axis, ROTY(2) about the Y-axis). UY(1) and UY(3) respectively denote the relative linear motion degrees of freedom between endpoint 1 and endpoint 3, implying UY(1)−UY(3)≠0.
6) Simulation of the flywheel: Use mass elements with rotational inertia I in only one direction to simulate the flywheel.
7) Setting constraint: Release the UY degree of freedom for endpoint 1 and endpoint 3 of the inerter, release the degree of freedom corresponding to the rotational inertia I in only one direction for the flywheel 2, and fully constrain the degrees of freedom for other nodes.
8) Setting constrain with the ground or attached structure: When connecting with other structures, adopt a shared node approach. When connecting with the ground, add a point element at the connection point and fully constrain it.
9) Complete the construction of “inerter unit” within the finite element software platform, complement the finite element modeling of the remaining components of the entire structure, and initiate the calculation and solution extraction, analysis, and processing according to the standard workflow and solution settings.

Constraint setting for node Motion degrees of freedom: The two endpoints of the inerter, corresponding to nodes 1 and 3 of the inerter unit, can be connected separately to the ground and the attached structure, or separately to the structure. When nodes 1 and 3 of the inerter are connected to the ground and the attached structure respectively, node 1 is fixed, constraining all degrees of freedom (in other cases, it can be connected to other objects, and node constraints can be adjusted accordingly); node 2 is released from displacement UY(2) and rotation ROTZ (or ROTX, ROTY), with all other degrees of freedom constrained; node 3 is released from displacement UY(3) degree of freedom, while all other degrees of freedom are constrained to be identical to those of the corresponding nodes on the structure. When nodes 1 and 3 of the inerter unit are connected to the structure separately, the degrees of freedom of nodes 1 and 3 are the same as those of the corresponding nodes on the structure; node 2 is released from displacement UY(2) and rotation ROTZ (or ROTX, ROTY), with all other degrees of freedom constrained.

Connection setup of the inerter unit with the ground or attached structure: During the finite element modeling process, when node 1 is connected to the ground, it is necessary to add a point element at node 1 with mass and rotational inertia properties set to zero. When nodes 1 and 3 are connected to the structure, nodes 1 and 3 are directly connected to the nodes generated after meshing the structure, and no additional point elements need to be added. Additionally, when the inerter unit is grounded, it can be grounded at either end of the lead screw, namely node 1, or at either end of the rigid link, namely node 3.

The inerter finite element simulation method provided in the invention, can not only be applied to ANSYS but also can be adapted for use in other numerical simulation software platforms, such as multibody dynamics software platforms like Universal Mechanism (UM), SIMPACK, or other types of numerical simulation software platforms. The inerter finite element simulation method provided by the present invention analyzes the characteristics of the inerter, utilizes the existing elements in the finite element platform, obtains the physical and mechanical parameters of the inerter, constructs inerter unit in the finite element environment, and realizes the finite element simulation of inerter. This inerter finite element simulation method expands the theoretical research approaches for inerter.

Summarily, the steps involved in inerter finite element simulation generally include establishing coordinate systems, creating nodes, defining elements between nodes, assigning properties to elements, and setting constraints on node and element degrees of freedom. After completing the inerter finite element simulation, when used for structural analysis, it also involves steps such as setting the loads and constraints on the structural system, defining solution parameters, performing loading and solving, and post-processing of results. The procedure as follows:

First, select a typical inerter based on translational-to-rotational conversion mechanism as the object for mechanical analysis. Then, condense a generalized translational-to-rotational conversion mechanism through thorough analysis of its structural characteristics and working principles. This will help understand and describe the behavior of the inerter and lay the foundation for subsequent simulation and modeling work.

The above translational-to-rotational conversion mechanism refers to the process where the axial forces acting on the inerter's two endpoints are transmitted through a transmission mechanism to generate torque on the flywheel. This conversion transforms the linear motion induced by the axial forces into rotational motion of the flywheel due to the applied torque. Moreover, this process amplifies the system's inertia.

This is specifically reflected in the following aspects:
(a) The ratio between the angular displacement of the flywheel and the relative linear displacement between the two endpoints is equal to the total gear ratio Γ of the transmission mechanism.
(b) The ratio between the axial forces acting on the two endpoints and the torque applied to the flywheel is also equal to the total gear ratio Γ of the transmission mechanism.
(c) The effect of the torque acting on the flywheel is to cause it to rotate with an angular acceleration \ddot{θ} and a rotational inertia I, to where I=m_{f}R², m_{f} is the physical mass of the flywheel, and R is the radius of the flywheel.
(d) The output of the inerter at both endpoints conforms to the inertial force expression.
(e) The inertial amplification feature of the inerter is reflected in the ratio of inertial mass to the actual physical mass of the flywheel, which equals the total gear ratio of the transmission mechanism I′ multiplied by the square of the flywheel radius R. Additionally, the physical mass of the flywheel is very small, so the axial inertial force m_{f}·Δ\ddot{x} can be neglected. Thus, there is no inertial force term, only the inertial force term m_{b}·Δ\ddot{x} in the dynamic equations.
(f) Determination of the direction of rotational inertia: Based on the differences and connections in the directions of rotational inertia in gear-rack and ball screw inerter, it is found that the direction of rotational inertia of the inerter's flywheel, based on the translational-to-rotational conversion mechanism, can be either perpendicular to or parallel with the main axis of the inerter.

Here is the finite element implementation of the translational-to-rotational conversion mechanism:

Coordinate system setup: Define a spatial local coordinate system {B} within the global coordinate system {A} of the finite element software platform. Establish the inerter unit of finite element in {B}, ensuring that the main axis of the inerter unit aligns with the Y-direction of {B}. Adjust the origin position and orientation of the spatial local coordinate system {B} to achieve translation and rotation within the global coordinate system {A}, thereby enabling the establishment of the inerter unit at any position and orientation within the global coordinate system {A}. This inerter finite element simulation method is applicable to both two-dimensional and three-dimensional finite element models, with similar principles applying within two-dimensional coordinate systems. The following description is based on the spatial local coordinate system {B}, with the main axis of the inerter unit aligned with the Y-direction of {B}.

Node creation: Create three nodes with the following coordinates: Node 1 coordinates (x₀, y₁, z₀), Node 2 coordinates (x₀, y₂, z₀), Node 3 coordinates (x₀, y₃, z₀). Node 1 and Node 3 correspond to the locations of the inerter endpoints, while Node 2 corresponds to the location of the inerter flywheel.

Simulation of translational-to-rotational conversion: Utilize rigid spring elements to connect Node 2 and Node 3, simulating the rigidity of the inerter's rigid link. This rigid link is considered as the “rigid arm”. By employing rigid spring elements, this simulation method not only reflects the minimal axial deformation and force characteristics experienced by the rigid link but also reduces the degrees of freedom compared to rigid beam elements.

Using constraint equations to simulate the motion transformation between the relative linear motion of the inerter's two endpoints and the rotational motion of the flywheel, based on the translational-to-rotational conversion mechanism and the relationship between the ratio of relative translational motion and flywheel rotation, the relationship equation is as following:

$$ROTZ ( 2 ) = Γ \cdot ( UY ( 3 ) - UY ( 1 ) )$$

Thus, the motion transformation relationship between the relative linear motion of the inerter's two endpoints and the rotational motion of the flywheel within the finite element software platform is simulated.

Flywheel simulation: The flywheel is simulated using a mass element with special properties assigned. Specifically, only one degree of freedom direction is allowed for rotational inertia properties. For example, for an RTOX element, the rotational inertia in the direction of the element's degree of freedom is assigned as I=IXX; for an RTOY element, it's assigned as I=IYY; and for an RTOZ element, it's assigned as I=IZZ. Here, IXX, IYY, and IZZ represent the values of rotational inertia along the corresponding degree of freedom direction.

Setting constraints for node motion degrees of freedom: The two endpoints of the inerter, namely Node 1 and Node 3 of the inerter element, can be connected separately to the ground and the attached structure or individually to the structure. When Node 1 and Node 3 of the inerter element are connected to the ground and the structure, respectively, Node 1 is fixed, constraining all degrees of freedom (in other cases, it can be connected to other objects, and node constraints can be adjusted accordingly); Node 2 is released from displacement UY(2) and rotation ROTZ (or ROTX, ROTY) degrees of freedom, with other degrees of freedom constrained; Node 3 is released from the displacement UY(3) degree of freedom, with other degrees of freedom constrained to be the same as the corresponding nodes on the structure. When Node 1 and Node 3 of the inerter element are connected separately to the structure, their degrees of freedom are the same as those of the corresponding nodes on the attached structure; Node 2 is released from displacement UY(2) and rotation ROTZ (or ROTX, ROTY) degrees of freedom, with other degrees of freedom constrained.

Setting connection of the inertial unit with the ground or attached structure: In the finite element modeling process, when nodes 1 and 3 are connected to the structure, they are directly connected to the nodes generated after partitioning the structure mesh, without the need to add additional point elements.

Bringing together the above steps, the finite element simulation of the inertial unit is completed.

The similarities and differences between gear-rack and ball screw inerters:

As shown in FIGS. 2 and 3, the transmission direction of gear-rack and ball screw inerters differ, but their inertia amplification mechanisms are the same. Both transmission structures convert the linear motion of the inerter's endpoints into the rotational motion of the flywheel, amplifying the inertial effect of the flywheel. However, there are formal differences between the two, reflected in the direction of the flywheel's rotation freedom (or the direction of the rotational inertia). In gear-rack inerters, the axis of rotation of the flywheel is perpendicular to the main axis of the inerter, while in ball screw inerters, the axis of rotation of the flywheel is the same as the main axis of the inerter. This indicates that for inerters based on translational-to-rotational conversion mechanisms, the direction of freedom for flywheel rotation can either be perpendicular to the main axis of the inerter or parallel to it.

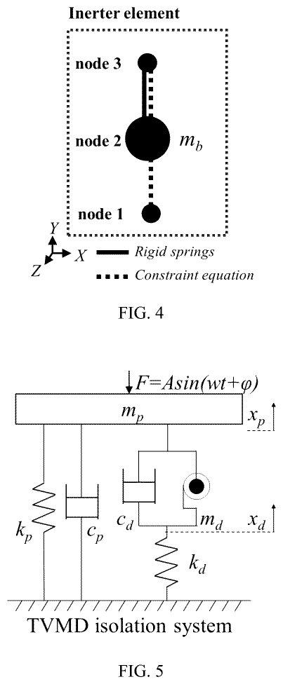

Finally, the schematic diagram of the finite element simulation of the inerter is shown in FIG. 4.

Below is a specific implementation example of the first aspect of the invention (all physical quantities in the example are based on the international system of units or derived from it):

### Implementation Example: Single Degree of Freedom System Subjected to Harmonic Loading

Consider the single degree of freedom (SDOF) system subjected to harmonic excitation, as shown in FIG. 5. The vibration isolator consists of a tuned viscous mass damper (TVMD) system and the main system's spring and damping units connected in parallel. The TVMD system includes an inerter unit and a damping element connected in parallel and then connected in series with a spring element, forming a classical system with inertial damping. One end of the vibration isolator is fixed to the ground, while the other end is connected to a mass m subjected to vertical downward harmonic excitation F.

The objective is to compute the acceleration response and support reaction at the endpoint.

In this system, the motion equation can be represented by:

$$m \ddot{x} + c \dot{x} + kx = {F}_{0} sin ( ω t )$$

Where, x is the displacement of the mass from the equilibrium position;
\ddot{x} is the acceleration of the mass;
\dot{x} is the velocity of the mass;
F₀ is the amplitude of the harmonic force;
ω is the angular frequency of the harmonic force.

This example demonstrates the analysis of forced vibration of a single degree of freedom system with a TVMD, providing insights into the acceleration response and support reaction at the endpoint.

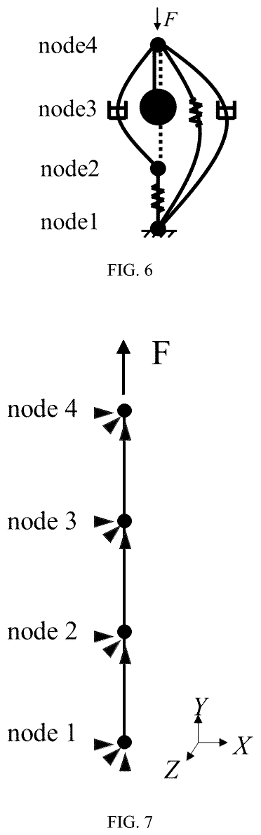

As shown in FIG. 6, define four nodes with the following coordinates: Node 1 at (0,0), Node 2 at (0,h), Node 3 at (0,2h), and Node 4 at (0,3h). A rigid spring is used to simulate the rigid rod between Node 2 and Node 3, where the rigid spring is modeled using a high stiffness unit with a stiffness value set to 1×10¹⁰ N/m.

Use node degree of freedom constraint equations to simulate the function of rack, describing the degree of freedom relationship between nodes 1, 2, and 3, and depicting the translational-to-rotational conversion mechanism. Here, the motion amplification factor Γ is set to 1, thus ROTZ(2)=UY(3)−UY(1).

Use finite element mass elements to simulate the flywheel, and the rotational inertia can be on any degree of freedom, such as Ixx, Iyy, or Izz. Here, set it as Izz=100, equivalent to an inertial mass.

Use the basic finite element to simulate the spring k_{d} of the TVMD system between node 1 and node 2. Set k_{d}=1×10⁴ N/m.

Use the basic finite element to connect node 2 and node 4 to simulate the damping c_{d} of the TVMD system. Set c_{d}=1×10³ N·s/m.

Use the basic finite element to connect node 1 and node 4 to simulate the spring kₚ of the main system. Set kₚ=2×10⁷ N/m.

Use the basic finite element to connect node 1 and node 4 to simulate the damping cₚ of the main system. Set cₚ=6×10⁴ N·s/m.

Connect the mass mₚ in the UY direction at node 4 to simulate the mass of the main structure in the single-degree-of-freedom system. Set mₚ=1×10⁴ kg.

Node 1 is fixed to the ground, constraining all degrees of freedom. Node 2 is released in the UY direction, constraining all other degrees of freedom. Node 3 is released in the UY and ROTZ (or ROTX, ROTY) directions, with all other degrees of freedom constrained. Node 4 is released in the UY direction, with all other degrees of freedom constrained.

The sinusoidal load F=−300×sin (2π×DT×J) is defined, where the integration step DT is 0.1 s, and the solution duration is 10 s. The results are tabulated in Table 1. The schematic diagram of the single-degree-of-freedom system with an inerter is shown in FIG. 7.

TABLE 1

| Physical object | | Finite element simulation | Parameter setting |
|---|---|---|---|
| Inerter of TVMD | Rack end point | Node 2 | \ |
| | Flywheel | Node 3 | \ |
| | Upper rod end point | Node 4 | \ |
| | Rod | High stiffness elements | The rigid spring has a |
| | | | stiffness value set to |
| | | | 1 × 10¹⁰ N/m |
| | Inertial mass m_{d} | Mass elements | IZZ = m_{d} = 100 |
| | Translational-to- | Constraint equation | ROTZ(2) = UY(1) − |
| | rotational conversion | | UY(3) |
| | mechanism | | |
| Spring of TVMD | k_{d} | Between node 1 and node 2, basic | k_{d} = 1 x 10⁴ N/m |
| | | finite elements are used | |
| Damping of | c_{d} | Betweem node 2 and node 4, | c_{d} = 1 × 10³ N · s/m |
| TVMD | | basic finite elements are used | |
| Mass of main | mₚ | Mass elements | mₚ = 1 × 10⁴ kg |
| structure | | | |
| Spring of main | kₚ | Between node 1 and node 4, basic | kₚ = 2 × 10⁷ N/m |
| structure | | finite elements are used | |
| Damping of main | cₚ | Between node 1 and node 4, basic | cₚ = 6 × 10⁴ N · s/m |
| structure | | finite elements are used | |
| Constraints | \ | Constraining all degrees of | \ |
| | | freedom of Node 1 to Node 4; | |
| | | Releasing the displacement in | |
| | | the UY direction of Node 2; | |
| | | Releasing the displacement in | |
| | | the UY and rotation ROTZ | |
| | | directions of Node 3; | |
| | | Releasing the displacement in | |
| | | the UY direction of Node 4. | |
| Load | \ | −300*SIN(2*PI*DT*J) | \ |
| Unit | \ | Unified into the international | \ |
| | | system of units SI | |

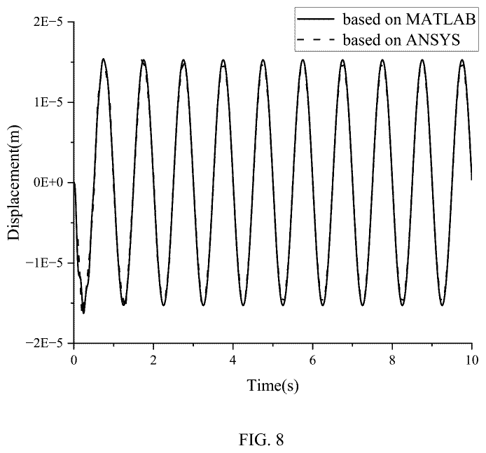

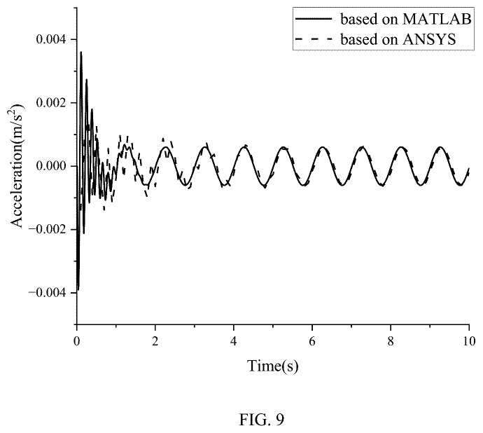

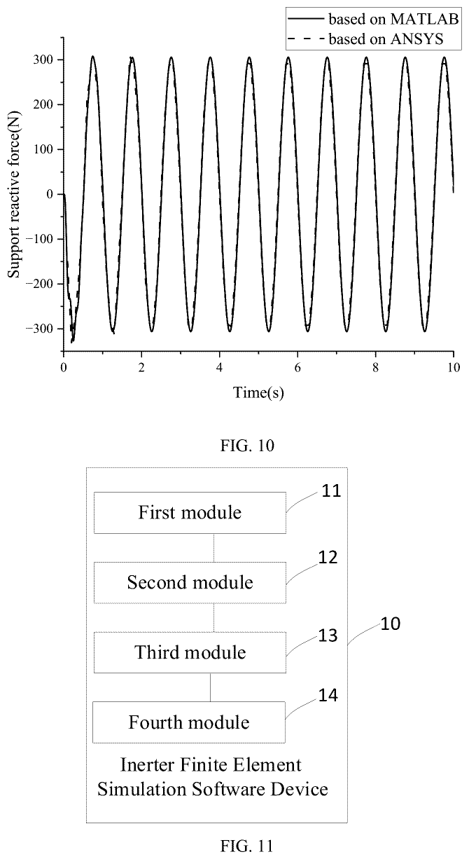

The comparative analysis and validation against analytical solutions based on the MATLAB platform are depicted in FIGS. 8 to 10. The results indicate that the implementation of the proposed inerter finite element simulation method in the finite element software aligns well with the analytical solutions obtained from the MATLAB platform.

Based on the same invention concept, the second aspect of the present invention provides a software device for finite element simulation of inerter (i.e., inerter finite element simulation software device), as shown in FIG. 11. It includes: a first module 11, a second module 12, a third module 13, and a fourth module 14. The first module 11 is used to obtain the structural parameters of the inerter, including dimensional and positional information. The second module 12 is used to simulate the physical properties of the rigid rod and flywheel in the inerter in the local coordinate system of the finite element platform based on the structural parameters and the finite element platform. The third module 13 is used to simulate the translational-to-rotational conversion and inertia amplification mechanism of the inerter based on the transformation of the rack on the rigid rod and flywheel in the inerter, as well as the physical properties. The fourth module 14 is used to obtain the force and constraint information of the inerter, combined with the translational-to-rotational conversion and inertia amplification mechanism.

Alternatively, in some implementations of the second aspect presented in the invention, as depicted in FIG. 11, the inerter unit finite element simulation software device 10 includes a fourth module 14. This module is responsible for establishing, within the global coordinate system of the finite element platform, the relevant structures except from the inerter. It also manages the reception of external load information applied to both the attached structures and the inerter, considering their actual connection relationship. Additionally, it oversees the computational process within the finite element platform to solve and acquire dynamic response data for both the inerter and attached structures.

The inerter finite element simulation device provided in the invention enables the construction of inerter unit within the finite element environment, facilitating the accurate acquisition of inertial data for inerter. This allows for the finite element simulation of inerters, thereby, it broadens the theoretical research methods and avenues for studying inerters.

Based on the same technological concept, the third aspect of the invention provides an electronic device, including: one or more processors; storage memory; one or more programs, one or more of which are stored in storage memory and configured to be executed by one or more processors, wherein one or more programs are configured to: implement any one of the inerter finite element simulation methods as described in the first aspect of the present invention.

The electronic devices provided in the implementations of the present invention may be specifically designed and manufactured for the intended purposes, or may alternatively include known devices in general-purpose computers. These devices have computer programs stored therein, which are selectively activated or reconfigured. Such computer programs may be stored on any type of medium suitable for storing electronic instructions, which may be coupled to a bus.

Compared to existing technologies, the present invention offers the following beneficial technical effects: The electronic device provided by the present invention analyzes the characteristics of the inerter, selects the basic nodes related to the inerter, integrates the parameters of these basic nodes into the finite element platform, and utilizes the inherent functionality of the finite element platform to achieve finite element simulation of the inerter and attached structures. This allows for the accurate and convenient acquisition of inertia data and engineering structures data for the inertial mechanism, expanding the means of studying inerter. It further enhances the theoretical simulation and analysis level of inerter, breaks through the technical bottlenecks of coupled numerical simulation and analysis of inerter with complex engineering structures, and provides effective theoretical guidance for practical engineering applications of inerter.

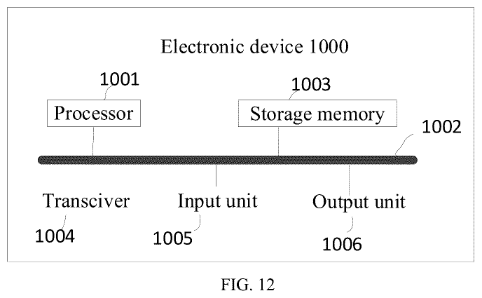

In an optional implementation, the present invention provides an electronic device, as illustrated in FIG. 12. The electronic device 1000 depicted in FIG. 12 includes a processor 1001 and a storage memory 1003. The processor 1001 is electrically connected to the storage memory 1003, such as through a bus 1002.

The processor 1001 can be a CPU (Central Processing Unit), a general-purpose processor, DSP (Digital Signal Processor), ASIC (Application Specific Integrated Circuit), FPGA (Field-Programmable Gate Array), or any other programmable logic device, transistor logic device, hardware component, or any combination thereof. It can implement or execute various exemplary logic blocks, modules, and circuits described in the disclosed content of the present invention. The processor 1001 can also be a combination that performs computational functions, such as a combination of one or more microprocessors, DSPs, and microprocessor combinations.

The bus 1002 may include a pathway for transmitting information between the above components. The bus 1002 can be a PCI (Peripheral Component Interconnect) bus or an EISA (Extended Industry Standard Architecture) bus, among others. The bus 1002 may be divided into address lines, data lines, control lines, and so forth. For ease of representation, in FIG. 12, it is depicted with a single thick line, but this does not imply that there is only one bus or one type of bus.

The storage memory 1003 can be a ROM (Read-Only Memory) or any other type of non-volatile storage device capable of storing static information and instructions. It can also be a RAM (Random Access Memory) or any other type of volatile storage device capable of storing information and instructions. Additionally, it can be an EEPROM (Electrically Erasable Programmable Read-Only Memory), CD-ROM (Compact Disc Read-Only Memory), or other optical disc storage, including compressed discs, laser discs, CDs, DVD-ROMs, Blu-ray discs, etc. It may also include magnetic storage media or other magnetic storage devices. Furthermore, it can encompass any other media capable of carrying or storing program code in the form of instructions or data structures and accessible by a computer, but not limited to these examples.

Optionally, the electronic device 1000 may include a transceiver 1004. This component facilitates both signal reception and transmission, enabling wireless or wired communication between the electronic device 1000 and other devices for data exchange. It's worth noting that multiple transceivers 1004 may be employed in practical applications.

Optionally, the electronic device 1000 may further include an input unit 1005. This unit is designed to receive input information in the form of digits, characters, images, and/or audio, or to generate key signal inputs related to user settings and functional controls of the electronic device 1000. The input unit 1005 may include, but is not limited to, a touchscreen, a physical keyboard, function keys (such as volume control keys, power keys, etc.), a trackball, a mouse, a joystick, a camera, a microphone, or a combination thereof.

Optionally, the electronic device 1000 may further include an output unit 1006. This unit is designed to output or display information processed by the processor 1001. The output unit 1006 may include, but is not limited to, a display device, speakers, a vibration device, or a combination thereof.

FIG. 12 illustrates the electronic device 1000 with various components, it should be understood that the presence of all depicted components is not required. Alternatively, more or fewer components may be implemented or present.

Optionally, the storage memory 1003 is utilized for storing application program code to execute the methods of the present disclosure and it is controlled for execution by the processor 1001. The processor 1001 executes the application program code stored in the storage memory 1003 to implement any of the finite element simulation methods of the present implementations.

Based on the same conceptual framework, in a fourth aspect, the present invention provides a computer-readable storage medium storing at least one instruction, at least one segment of program, code set, or instruction set. The at least one instruction, at least one segment of program, code set, or instruction set is loaded and executed by a processor to implement any of the finite element simulation methods described in the first aspect of the present invention.

The steps, measures, and approaches discussed in the present invention can be alternated, modified, combined, or deleted. Furthermore, other steps, measures, and approaches within the scope of the operations, methods, and processes discussed in the present invention can also be alternated, modified, rearranged, decomposed, combined, or deleted. Additionally, techniques from the prior that have steps, measures, and approaches similar to those disclosed in the present invention can also be alternated, modified, rearranged, decomposed, combined, or deleted.

The terms “first” and “second” are used solely for descriptive purposes and should not be construed to indicate or imply relative importance or the quantity of the indicated technical features. Therefore, features designated with “first” or “second” may explicitly or implicitly include one or more instances of that feature. In the description provided in the invention, unless otherwise specified, the term “multiple” signifies two or more.

It should be understood that although the steps in the flowcharts of the figures are shown sequentially according to the direction of the arrows, these steps are not necessarily executed in the order indicated by the arrows. Unless explicitly stated otherwise, there are no strict restrictions on the order in which these steps are performed, and they may be executed in a different sequence. Additionally, at least some of the steps in the flowcharts may include multiple sub-steps or stages, which may not necessarily be completed simultaneously but can be executed at different times. The execution sequence of these sub-steps or stages may also not necessarily be sequential but may alternate or occur in rotation with other steps or sub-steps of other steps.

The above-described implementations are merely exemplary and should be understood as illustrative rather than limiting in any way. Various modifications and variations can be made to the implementations without departing from the principles described in the invention. All such modifications and variations are considered within the scope of the invention and its protection.

What is claimed is:

1. A finite element simulation method for inerter, comprising the following steps:
obtaining structural parameters comprising dimensional and positional information of the inerter;
simulating physical and mechanical properties of a rigid rod and a flywheel in the inerter based on the structural parameters and a finite element platform, within a local coordinate system of the finite element platform;
simulating translational-rotational conversion and inertia amplification mechanisms of the inerter based on conversion functions, which are determined by a rack on the rigid rod and the flywheel, as well as their physical and mechanical properties; and
obtaining force and constraint information of the inerter, and then integrating the translational-rotational conversion and the inertia amplification mechanisms to implement simulation of the inerter in the finite element platform.

2. The finite element simulation method for the inerter as claimed in claim 1, wherein steps in the local coordinate system of the finite element platform comprise:
constructing a spatial local coordinate system within a global coordinate system of the finite element platform, where the local coordinate system is a cartesian coordinate system; and
aligning a principal axis of the inerter with a Y-axis direction of the local coordinate system.

3. The finite element simulation method for the inerter as claimed in claim 1, wherein steps for simulating the translational-rotational conversion and the inertia amplification mechanisms of the inerter comprise:
based on a conversion direction of the inerter, constructing constraint equations for an axial translational displacement and an angular displacement of the flywheel at two ends of the inerter, to determine a translational or rotational displacement conversion relationship between the rigid rod and the flywheel; and
in the finite element platform, establishing a transformation formula between an axial force at the two ends of the inertia and a torque on the flywheel, and combining the constraint equations to achieve simulation of the translational-rotational conversion and the inertia amplification mechanisms of the inerter.

4. The finite element simulation method for the inerter as claimed in claim 1, wherein steps for implementing the simulation of the inerter in the finite element platform comprise:
based on the force and constraint information, simulating connection relationship information between the inerter and an attached structure; and
integrating the translational-rotational conversion and the inertia amplification mechanisms, to complete inertia finite element simulation of the inerter.

5. The finite element simulation method for the inerter as claimed in claim 1, wherein, after the steps for implementing the simulation of the inerter in the finite element platform, the finite element simulation method further comprises:
in a global coordinate system of the finite element platform, constructing additional attached structures apart from the inerter;
according to an actual connection relationship between the attached structures and the inerter, receiving external load and constraint information applied on both the attached structures and the inerter; and
utilizing a computational process of the finite element platform to solve and obtain dynamic response data of the inerter and the attached structures.

6. The finite element simulation method for the inerter as claimed in claim 1, wherein the inerter comprises a gear rack mechanism or a ball screw mechanism.
